(19) United States
(12) Patent Application Publication
(10) Pub. No.: US 2023/0163343 A1
(43) Pub. Date: May 25, 2023

(54) BATTERY CELL POUCH BENDING APPARATUS FOR SECONDARY BATTERY PACKAGING SYSTEM AND POUCH BENDING METHOD

(71) Applicants: MPLUS CORP., Cheongun-si (KR); SK On Co., Ltd., Seoul (KR)

(72) Inventors: Jong Sung KIM, Seongnam-si (KR); Hui Jin PARK, Cheongju-si (KR); Bong Uk JEONG, Gunwi-gun (KR); Ji Eun AHN, Daejeon (KR); Wook Kyoung KIM, Daejeon (KR); Sang Jun PARK, Daejeon (KR)

(73) Assignees: MPLUS CORP., Cheongun-si (KR); SK On Co., Ltd., Seoul (KR)

(21) Appl. No.: 17/959,277

(22) Filed: Oct. 3, 2022

Related U.S. Application Data
(63) Continuation of application No. PCT/KR2020/008021, filed on Jun. 20, 2020.

(30) Foreign Application Priority Data
Apr. 2, 2020 (KR) 10-2020-0040222

(51) Int. Cl. H01M 10/04; H01M 50/105; B29C 53/04

(52) U.S. Cl. CPC H01M 10/0404; H01M 50/105; B29C 53/04

(57) ABSTRACT

Proposed is a pouch bending guide apparatus, for a secondary battery packaging system, in which a pouch sheet (2A) is folded by folding a bending jig (20) toward a base jig (30) with the pouch sheet (2A) placed on the base jig (30) and the bending jig (20) so as to mount a battery cell inside a pouch (2), the pouch bending guide apparatus including a bending knife (40) which supports, from the inside of the pouch (2), a bending lateral surface (2BS) of the pouch (2) formed while the pouch sheet (2A) is folded by the bending jig (20).

### TECHNICAL FIELD

The present disclosure relates generally to pouch bending guide apparatus and pouch bending method for a secondary battery packaging system. More particularly, the present disclosure relates to pouch bending guide apparatus and pouch bending method for a secondary battery packaging system in which during the folding of a pouch, a bending lateral surface of the pouch can be prevented from being deformed concavely. The present disclosure relates to the bending of a pouch for a secondary battery packaging system, and is intended to prevent a bending portion of the pouch from being moved to the inside of a main chamber by using a bending knife. The prevention of the bending portion of the pouch from being moved to the inside of the main chamber means to prevent a bending lateral surface on one side of the pouch from being pushed to the inside of the pouch when forming the pouch by folding a pouch sheet.

### BACKGROUND ART

A secondary battery can be recharged and can be small and large-capacity. The secondary battery may be a can-type secondary battery or pouch-type secondary battery according to the shape of an outer casing of the secondary battery, wherein the pouch-type secondary battery consists of a battery cell having an electrode tab formed on one side of an electrode plate, and a pouch that covers and seals the electrode plate so that the electrode tab is drawn out of the pouch. The battery cell has a separator interposed between a plurality of positive and negative electrode plates, and the battery cell is mounted and sealed inside the pouch, and the electrode tab on one side of the battery cell is drawn out of the pouch. A battery having a battery cell mounted in the pouch is referred to as a pouch-type secondary battery.

In this case, when forming the pouch in which the battery cell is mounted, the center part of a pouch sheet having half battery cell receiving parts is folded and the battery cell is mounted in the battery cell receiving part of the inside of the pouch.

However, while folding and bending the center part of the pouch sheet, the center part of the pouch sheet is pushed inward, and a bending lateral surface of the pouch is deformed concavely inward. That is, when the pouch sheet is folded, the bending lateral surface of the pouch 2 is moved inward and is deformed concavely.

In the case of a battery without a bottom, while a pouch is bent, a bending portion of the pouch is moved to the inside of a main chamber, and thus the size of the main chamber decreases. The movement of the bending portion of the pouch to the inside of the main chamber means that when forming the pouch by folding the pouch sheet, a bending lateral surface on one side of the pouch 2 is pushed to the inside of the pouch. Accordingly, during the bending of the pouch 2, the bending portion of the pouch is moved to the inside of the main chamber, and thus the size of the main chamber of the pouch decreases.

In addition, when the bending lateral surface of the pouch is deformed concavely inward, heat generated during the charging/discharging of the battery cell of a secondary battery is not efficiently discharged. A plurality of pouches (hereinafter, referred to as a pouch for convenience) in which battery cells are mounted is placed by standing side by side on a hanger frame, and the bending lateral surface of each of the pouches is in contact with a heat sink (which may be a metal plate having high thermal conductivity, for example, an aluminum plate) provided on the lower part of the hanger frame. In this state, heat generated in the pouch during the charging/discharging of the battery cell is transmitted from the bending lateral surface to the heat sink to be discharged. When the pouch has a concave deformation part formed in such a manner that the bending lateral surface of the pouch is recessed inward, the concave deformation part is not efficiently in contact with the heat sink. Accordingly, heat generated in the pouch during the charging/discharging of the battery cell is not efficiently transmitted from the bending lateral surface to the heat sink, and thus heat generated in the pouch during the charging/discharging of the battery cell is not efficiently discharged, and when the heat discharge from the pouch is not efficiently performed, the battery cell deteriorates or catches fire due to heat.

### DISCLOSURE

### Technical Problem

The present disclosure is intended to propose pouch bending guide apparatus and pouch bending method for a secondary battery packaging system having a new configuration in which a bending lateral surface of a pouch can be prevented from being deformed concavely in the bending process of folding a bending jig toward a base jig after a battery cell is placed on a pouch sheet, and heat generated during the charging/discharging of the battery cell of a secondary battery can be efficiently discharged from the pouch. That is, the present disclosure is mainly intended to prevent the bending lateral surface of the pouch from being recessed inward in the process of bending the pouch sheet to mount a battery cell in the pouch.

### Technical Solution

In order to accomplish the above objectives, according to the present disclosure, there is proposed a pouch bending guide apparatus, for a secondary battery packaging system, which folds a pouch sheet while a bending jig is folded toward a base jig with the pouch sheet placed on the base jig and the bending jig, the apparatus including: a bending knife which supports, from an inside of a pouch, a bending lateral surface of the pouch formed while the pouch sheet is folded by the bending jig.

### Advantageous Effects

According to the present disclosure, while folding and bending the center part of the pouch sheet, the center part of the pouch sheet is prevented from being pushed inward, thereby preventing the bending lateral surface of the pouch from being deformed concavely inward.

In addition, the bending lateral surface of the pouch is prevented from being pushed inward, thereby improving the exterior quality and reliability of the pouch.

### DESCRIPTION OF DRAWINGS

FIG. 1 is a picture showing a portion of a pouch having a concave deformation part formed in such a manner that a bending lateral surface of the pouch according to a conventional technology is recessed inward.

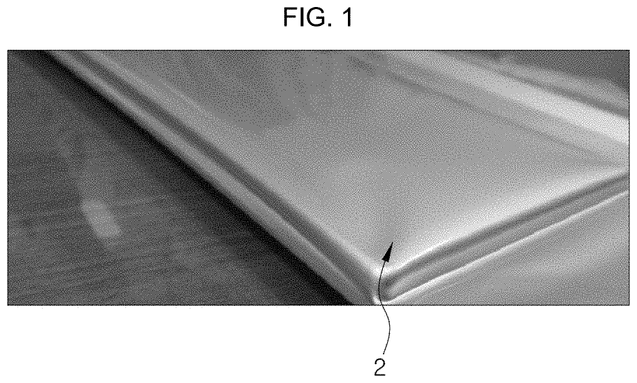

FIG. 2 is a top plan view showing the unfolded state of a base jig and a bending jig which are main parts of a pouch bending guide apparatus for a secondary battery packaging system according to the present disclosure, and a state in which a pouch sheet is placed by being unfolded on the base jig and the bending jig.

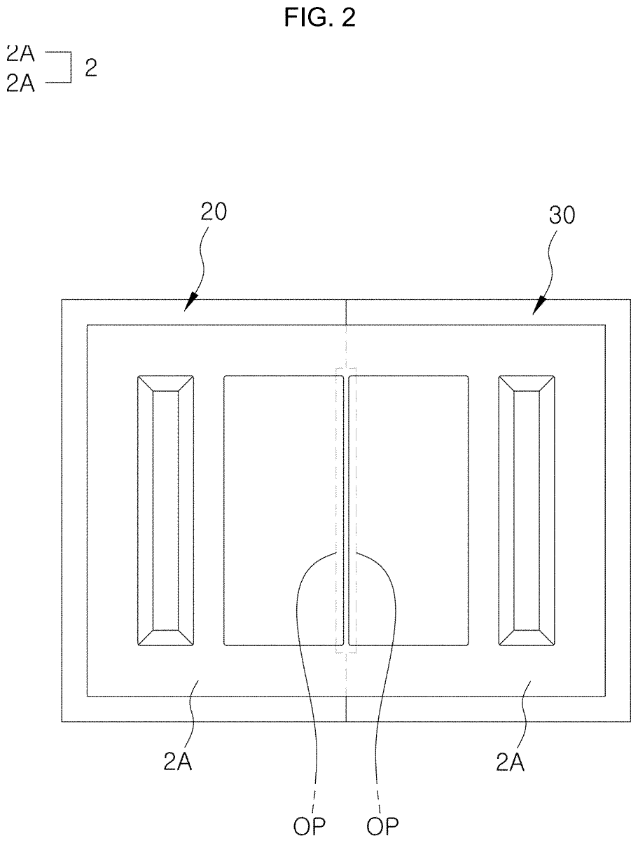

FIG. 3 is a perspective view showing a portion of the bending jig shown in FIG. 2.

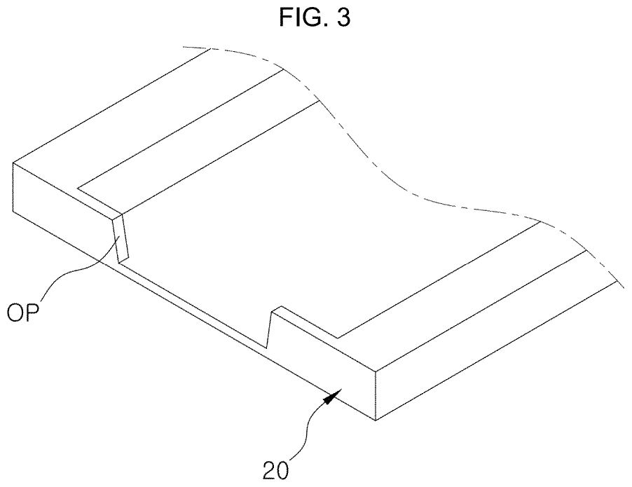

FIG. 4 is a perspective view showing a portion of the base jig shown in FIG. 2.

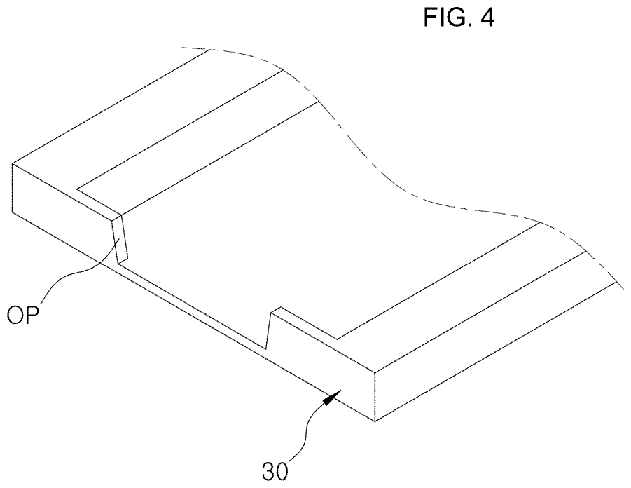

FIG. 5 is a perspective view showing a bending knife which is a main part of the pouch bending guide apparatus of the present disclosure.

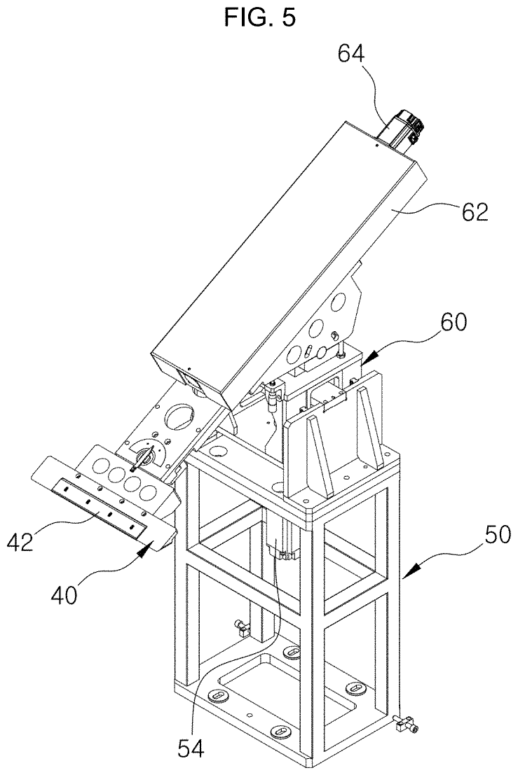

FIG. 6 is a rear view of FIG. 5.

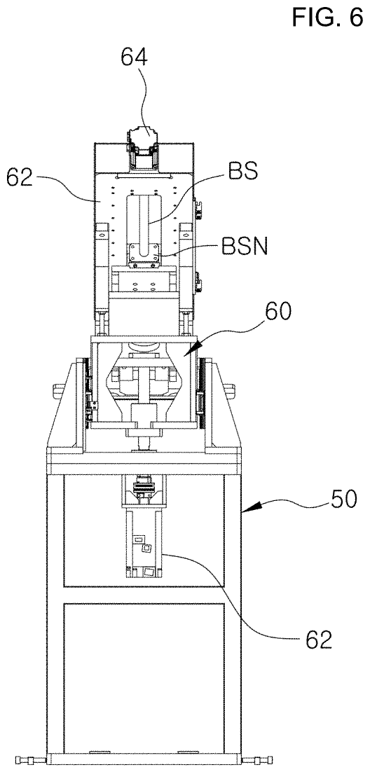

FIG. 7 a side view showing a state in which the bending knife is moved to the inside of the pouch sheet while the bending jig shown in FIG. 2 is folded toward the base jig.

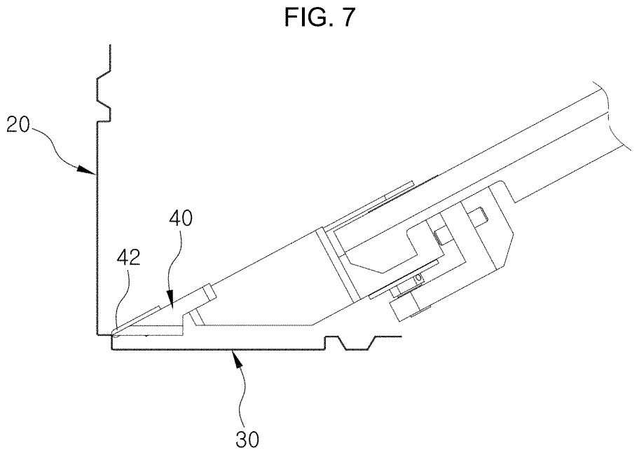

FIG. 8 is an enlarged side view showing a state before a stopper is in contact with the bending lateral surface of a pouch when forming the pouch by folding the pouch sheet shown in FIG. 7.

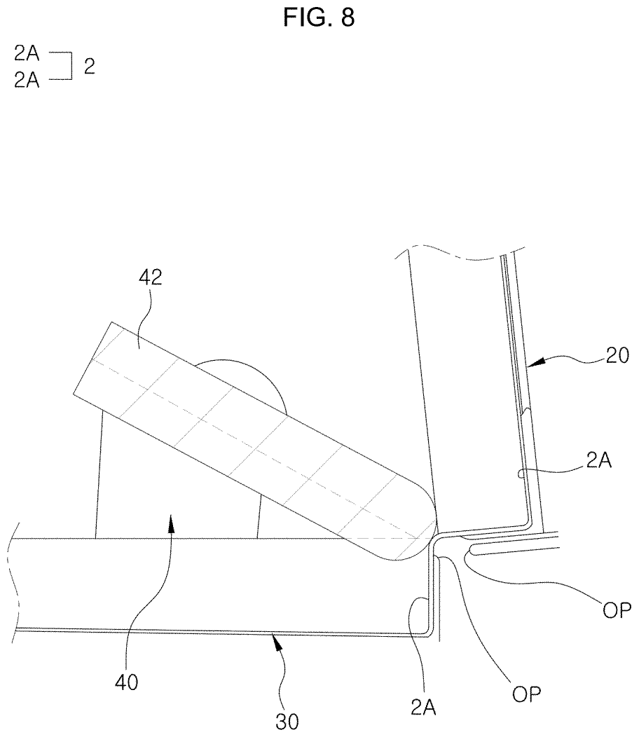

FIG. 9 is an enlarged side view showing a state in which the stopper is in contact with the bending lateral surface of the pouch when forming the pouch by folding the pouch sheet shown in FIG. 7.

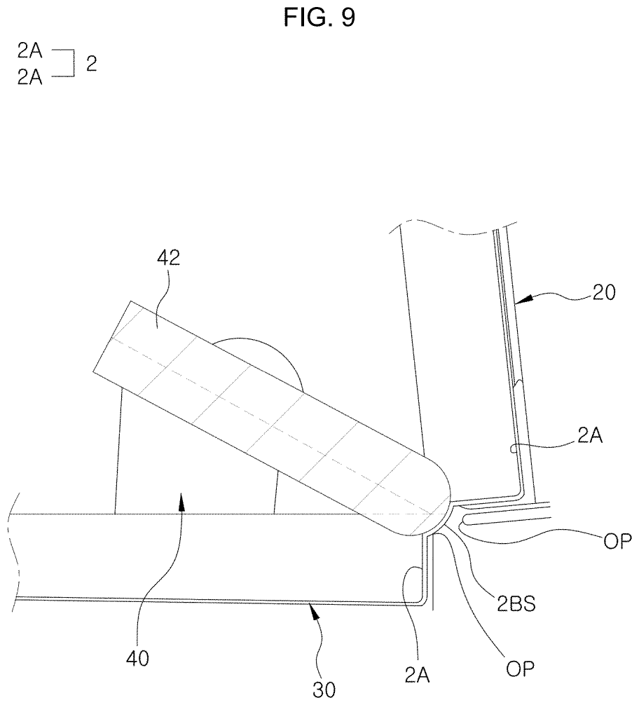

### BEST MODE

The present disclosure relates to a pouch bending guide apparatus for a secondary battery packaging system which folds a pouch sheet while the bending jig is folded toward the base jig with the pouch sheet placed on a base jig and a bending jig, the apparatus including a bending knife which supports, from the inside of a pouch, a bending lateral surface of the pouch formed while the pouch sheet is folded by the bending jig, wherein the bending knife is provided with a stopper, and while the pouch sheet is folded by the bending jig, the bending knife moves toward the inside of the pouch sheet such that a stopper supports the inner surface of the bending lateral surface of the pouch.

### MODE FOR INVENTION

The present disclosure relates to a pouch bending guide apparatus for a secondary battery packaging system which folds a pouch sheet 2A while the bending jig 20 is folded toward the base jig 30 with the pouch sheet 2A placed on a base jig 30 and a bending jig 20. The pouch bending guide apparatus of the present disclosure is provided with a bending knife 40 as a main part which supports, from the inside of a pouch, a bending lateral surface 2BS of the pouch 2 formed while the pouch sheet 2A is folded by the bending jig 20 such that the bending lateral surface 2BS of the pouch 2 is prevented from being pushed concavely inward, wherein the bending knife 40 is provided with a stopper 42 which supports the bending lateral surface 2BS from the inner surface of the pouch.

The inner surface of the base jig 30 is disposed to be directed upward. The base jig 30 is formed to have the shape of a rectangular plate. The inner surface of the base jig 30 is provided with a pouch battery cell receiving part seating groove having the shape of a concave half groove. The pouch sheet 2A for forming the pouch 2 in which a battery cell is mounted includes two half battery cell receiving parts relative to the center of the pouch sheet 2A, and each of the half battery cell receiving parts of the pouch has the shape of a rectangular groove protruding outward from the pouch sheet 2A, and thus a half pouch battery cell receiving part seating groove of the base jig 30 is formed to have the shape of a rectangular groove such that the half battery cell receiving part is seated in the half pouch battery cell receiving part seating groove.

The bending jig 20 is supported by a support frame 41 and is folded toward or unfolded from the inner surface of the base jig 30 by a bending operation unit (not shown). Even the inner surface of the bending jig 20 is provided with a concave half pouch battery cell receiving part seating groove. The pouch battery cell receiving part seating groove of the bending jig 20 also has the shape of a rectangular groove.

The base jig 30 is mounted to the support frame, and side walls of the base jig 30 and the bending jig 20 are coupled to each other by a hinge part. The inner surface of the base jig 30 and the bending jig 20 are disposed to face each other by folding the bending jig 20 toward the inner surface of the base jig 30, and the bending jig 20 is unfolded outward from the inner surface of the base jig 30. Each of the base jig 30 and the bending jig 20 is formed to have the shape of a plate having a pouch battery cell receiving part seating groove provided therein. The bending jig 20 is folded toward and unfolded from the base jig 30 relative to the hinge part.

While the bending jig 20 is unfolded from the base jig 30, the inner surface of the bending jig 20 is disposed to be directed upward.

A vacuum suction passage is formed inside each of the base jig 30 and the bending jig 20, and a plurality of vacuum suction holes communicating with the vacuum suction passage is formed in each of the inner surfaces of the base jig 30 and the bending jig 20 facing each other. The vacuum suction holes of the base jig 30 are connected with the vacuum suction passage of the inside of the base jig 30 and are open to the inner surface of the base jig 30. Additionally, the vacuum suction holes of the bending jig 20 are also connected with the vacuum suction passage of the inside of the bending jig 20 and are open to the inner surface of the bending jig 20.

The outer surface of the pouch sheet 2A placed on the inner surfaces of the base jig 30 and the bending jig 20 is disposed to face the vacuum suction holes of the base jig 30 and the vacuum suction holes of the bending jig 20.

The vacuum suction passage of the inside of the base jig 30 and the vacuum suction holes thereof, and the vacuum suction passage of the inside of the bending jig 20 and the vacuum suction holes thereof are connected with a vacuum device, which is not shown, by a connecting hose, a vacuum connection block 42, and a vacuum pressure charging block 51. Air is suctioned through the vacuum suction holes of the inner surface of the base jig 30 and the vacuum suction holes of the inner surface of the bending jig 20 by the vacuum device such that the pouch sheet 2A can be in close contact with the inner surface of the base jig 30 and the inner surface of the bending jig 20 by vacuum.

The vacuum device is connected with the vacuum suction passages of the base jig 30 and the bending jig 20 by a connection means such as a hose not shown, and while the pouch sheet 2A is suctioned on the base jig 30 and the bending jig 20 by the operation of the vacuum device, the bending jig 20 is folded toward or unfolded from the base jig 30 relative to the hinge part. Of course, the folding and unfolding operations of the bending jig 20 toward the base jig 30 may be performed by a bending operation means not shown. The bending operation means may use a known device such as a cylinder, and thus a detailed description thereof will be omitted.

The pouch sheet 2A is placed on the base jig 30 and the bending jig 20, and a battery cell is received in a half battery cell receiving part disposed on the base jig 30 among the pair of half battery cell receiving parts of the pouch sheet 2A, and while the two half battery cell receiving parts of the pouch sheet 2A are seated respectively in the pouch battery cell receiving part seating groove inside the base jig 30 and the pouch battery cell receiving part seating groove of the bending jig 20, the pouch sheet 2A is folded while the bending jig 20 is folded toward the base jig 30, and after the pouch sheet 2A is folded, the pouch 2 having the battery cell mounted in the half battery cell receiving part inside the pouch 2 is formed. Of course, while the two half battery cell receiving parts of the pouch sheet 2A are empty without battery cells, the pouch 2 may be formed by folding the pouch sheet 2A in half relative to the center of the pouch sheet 2A, and one side surface of even a pouch 2 without battery cells is formed as a folding side surface.

In this case, one side wall of the base jig 30 and one side wall of the bending jig 20 are connected to each other by the hinge part, and a bending guide opening part OP is formed on each of the side walls of the base jig 30 and the bending jig 20 such that the inner and outer surfaces of the side wall communicate with each other. The bending guide opening part OP is formed on each of the one side wall of the base jig 30 and the one side wall of the bending jig 20. The bending guide opening part OP is formed by passing through the side wall of each of the base jig 30 and the bending jig 20 from one side surface of the pouch battery cell receiving part seating groove formed inside each of the base jig 30 and the bending jig 20. The bending guide opening parts OP may be considered as guide holes to guide the bending lateral surface 2BS of the pouch 2 to be pushed to the outside when the stopper 42 to be described later pushes the inner surface of the bending lateral surface such that the bending lateral surface 2BS of the pouch 2 is prevented from being pushed to the inside of the pouch 2.

The pouch bending guide apparatus of the present disclosure is provided with the bending knife 40 which supports the bending lateral surface 2BS of the pouch 2 from the inside thereof when the pouch sheet 2A is folded.

When the base jig 3 and the bending jig 20 stop after moving along a movement path, the bending jig 20 is folded toward the base jig 30. In a case in which the movement path is a track, when the base jig 30 and the bending jig 20 stop after moving along the track, the bending jig 20 is folded toward the base jig 30. In a case in which the movement path is a turntable, when the base jig 30 and the bending jig 20 mounted to the turntable stop after moving according to the rotation of the turntable, the bending jig 20 is folded toward the base jig 30.

A bending knife frame 50 is disposed at a side of the movement path. When the movement path is a turntable, the bending knife frame 50 is disposed next to the turntable. A lift drive motor 62 is mounted to the bending knife frame 50. The motor shaft of the lift drive motor 62 is arranged in a vertical direction. The motor shaft of the lift drive motor 62 is provided with a lifting ball screw.

The bending knife frame 50 is provided with an LM guide. The LM guide is provided with a guide rail and a guide rail block, and the guide rail is arranged in a direction perpendicular to the bending knife frame 50. The guide rail block is coupled slidably to the guide rail. When the bending knife frame 50 is seen from the front, the guide rail is seen to include a pair of guide rails arranged respectively at left and right sides to be in parallel to each other.

A bending knife support frame 60 is coupled to the bending knife frame 50. The bending knife support frame 60 is coupled to the bending knife frame 50 such that the bending knife support frame 60 is moved upward and downward by the LM guide. The bending knife frame 50 is coupled to the guide rail block of the LM guide, and the bending knife support frame 60 is coupled to the bending knife frame 50 to move upward and downward.

The bending knife support frame 60 is provided with a lift ball screw nut. The lift ball screw nut is preferably provided on the center part of the lower surface of the bending knife support frame 60. The motor shaft of the lift drive motor 62 provided on the bending knife frame 50 is provided with the lifting ball screw, and the lifting ball screw nut provided in the bending knife support frame 60 is coupled to the lifting ball screw. Accordingly, as the motor shaft of the drive motor rotates, the bending knife support frame 60 may be raised and lowered on the bending knife frame 50 by the lifting ball screw and the lift ball screw nut.

The bending knife support frame 60 is provided with an LM guide. An inclined frame 62 is provided on the upper part of the bending knife support frame 60. When seen from the side of the bending knife support frame 60, the front end part of the inclined frame 62 is disposed to be lower than a base end part. That is, the rear side of the inclined frame 62 is disposed to be inclined such that the rear side of the inclined frame is raised higher than the front side thereof. The inclined frame 62 is provided with an LM guide. The LM guide provided on the inclined frame 62 is composed of a pair of guide rails and a guide rail block. When seen from the upper side of the inclined frame 62, the pair of guide rails disposed side by side at left and right sides is provided in the inclined frame 62. The pair of guide rails extends along the longitudinal direction of the inclined frame 62. The guide rail block is coupled slidably to the pair of guide rails.

The drive motor 64 is mounted to the base end part of the inclined frame 62. Since the inclined frame 62 is a component of the bending knife support frame 60, the drive motor 64 is configured to be mounted to the bending knife support frame 60. The motor shaft of the drive motor 64 is provided with a ball screw. The ball screw BS provided in the motor shaft of the drive motor 64 extends along the longitudinal direction of the inclined frame 62.

A moving frame is coupled to the LM guide provided in the inclined frame 62 of the bending knife support frame 60. The moving frame is coupled to the guide rail block coupled slidably to the guide rails of the inclined frame 62. The moving frame may slide on the inclined frame 62 of the bending knife support frame 60 due to the LM guide. That is, the moving frame may move forward and rearward on the inclined frame 62 of the bending knife support frame 60. The moving frame is configured to move forward and rearward at an inclined state on the bending knife support frame 60.

The drive motor 64 is mounted to the inclined frame 62, and the motor shaft of the drive motor 64 is provided with the ball screw BS, and the moving frame is provided with the ball screw nut BSN, and the ball screw nut BSN is coupled to the ball screw BS. Accordingly, as the motor shaft and ball screw BS of the drive motor 64 mounted to the inclined frame 62 rotate, the ball screw nut BSN moves rectilinearly along the ball screw BS such that the moving frame can move to the front and rear sides of the inclined frame 62. The moving frame may move forward and rearward at an inclined state thereof on the bending knife support frame 60.

The moving frame is provided with the bending knife 40. The bending knife 40 is formed to have a plate shape. The bending knife 40 is mounted to the moving frame and thus is disposed to be inclined such that the front side of the bending knife 40 is lower than the rear side thereof. In this case, the front lower surface of the bending knife 40 is formed as a horizontal surface. When the bending knife 40 is seen from a side thereof in a state in which the bending knife 40 is coupled to the moving frame, the front lower surface of the bending knife 40 is formed as a horizontal surface.

The bending knife 40 is provided with the stopper 42 so as to support the inner surface of the bending lateral surface 2BS of the pouch 2. The bending knife 40 includes a stopper seating groove such that the inside of the stopper seating groove and the upper surface of the bending knife communicate with each other, and the stopper 42 is seated in and coupled to the stopper seating groove. The stopper 42 protrudes more forward than the front of the bending knife 40. The front end part of the stopper 42 may be formed as a curved surface or a flat surface. The bending guide opening part OP is formed in each of the side walls of the base jig 30 and the bending jig 20 such that the inner and outer surfaces of the side wall communicate with each other, and the stopper 42 may be configured to have a width equal to or slightly smaller than the width of the bending guide opening part OP.

Meanwhile, according to the present disclosure, there is proposed a pouch bending method for a secondary battery packaging system, the method including: bending the pouch by folding the pouch sheet 2A while the bending jig 20 is folded toward the base jig 30 with the pouch sheet 2A placed on the base jig 30 and the bending jig 20; and supporting the bending lateral surface 2BS of the pouch 2 formed while the pouch sheet 2A is bent, from the inside of the pouch 2, by moving the bending knife 40 toward the inside of the pouch sheet 2A folded while the pouch sheet 2A is folded by the bending jig 20.

According to the pouch bending guide apparatus of the present disclosure having the above configuration, the bending knife 40 is provided with the stopper 42, and while the pouch sheet 2A is folded by the bending jig 20, the bending knife 40 is moved to the inside of the pouch sheet 2A such that the stopper 42 supports the inner surface of the bending lateral surface 2BS of the pouch 2.

Specifically, the base jig 30 and the bending jig 20 are unfolded relative to the hinge part by which the base jig 30 and the bending jig 20 are connected to each other, and the pouch sheet 2A is unfolded on the unfolded inner surfaces of the base jig 30 and the bending jig 20, and in this state, when the bending jig 20 is folded toward the base jig 30 relative to the hinge part, the pouch sheet 2A, which is unfolded, is also folded in half. This is the bending of the pouch.

When the bending jig 20 and a half pouch sheet 2A are folded toward the base jig 30 and a remaining half pouch sheet 2A, the bending knife 40 moves forward to the inside of the folding pouch sheet 2A. As the motor shaft and ball screw of the drive motor mounted to the inclined frame 62 of the bending knife support frame 60 rotate in one direction, the moving frame is moved forward by the ball screw nut and the ball screw, and the bending knife 40 mounted to the moving frame is moved forward to be moved to the inside of the pouch sheet 2A. With the bending jig 20 folded toward the base jig 30 at least in an acute angle, the bending knife 40 moves forward to the inside of the pouch sheet 2A.

The bending knife 40 moves to the inside of the folding pouch sheet 2A, and the stopper 42 provided on the bending knife 40 supports the bending lateral surface 2BS of the pouch 2 from the inner surface of the pouch 2. The area of the bending lateral surface 2BS of the pouch 2 pushed by the stopper 42 during the bending of the pouch 2 is increased such that the stopper 42 pushes many areas of the bending lateral surface 2BS. This is supporting the bending lateral surface of the pouch.

Accordingly, since the stopper 42 supports the bending lateral surface 2BS of the pouch 2 from the inner surface thereof, the bending lateral surface 2BS of the pouch 2 is prevented from being pushed inward. The front end part of the stopper 42 may be formed as a curved surface or a flat surface, and the curved or flat surface of the stopper 42 supports the bending lateral surface 2BS of the pouch 2 from the inside of the pouch 2. In this case, the bending guide opening part OP is formed in one side wall of each of the base jig 30 and the bending jig 20 such that the inner and outer surfaces of the side wall communicate with each other, and the stopper 42 of the bending knife 40 pushes the bending lateral surface 2BS of the pouch 2 outward through the bending guide opening parts, so the bending lateral surface 2BS of the pouch 2 can be prevented from being pushed inward. The stopper 42 pushes the bending lateral surface 2BS outward, and thus the pouch 2 in which the bending lateral surface 2BS is prevented from being pushed inward is formed.

Meanwhile, in a state in which the bending jig 20 and the half pouch sheet 2A are folded to be close to the upper surface of the bending knife 40, the bending knife 40 and the stopper 42 move rearward out of the bending jig 20 and the half pouch sheet 2A. As the motor shaft and ball screw BS of the drive motor 64 mounted to the inclined frame 62 of the bending knife support frame 60 rotate in different directions, the moving frame is moved rearward by the ball screw nut BSN and the ball screw BS, and the bending knife 40 and the stopper 42 mounted to the moving frame are moved rearward to be moved to the outside of the pouch sheet 2A from the inside thereof. While the bending jig 20 and the half pouch sheet 2A are folded to be close to the upper surface of the bending knife 40, the bending lateral surface 2BS of the pouch 2 is prevented from being pushed to the inside of the pouch 2. Accordingly, in the state in which the bending jig 20 and the half pouch sheet 2A are folded to be close to the upper surface of the bending knife 40, the bending knife 40 and the stopper 42 move rearward out of the bending jig 20 and the half pouch sheet 2A. After the bending knife 40 and the stopper 42 move out of the bending jig 20 and the half pouch sheet 2A, the bending jig 2 and the half pouch sheet 2A are completely folded toward the base jig 30 and the remaining half pouch sheet 2A, so that the pouch 2 in which the two half pouch sheets 2A are laid on each other can be formed.

Accordingly, in the pouch bending guide apparatus of the present disclosure, while folding and bending the center part of the pouch sheet 2A, the center part of the pouch sheet 2A is prevented from being pushed inward, thereby preventing the bending lateral surface 2BS of the pouch 2 from being deformed concavely inward. That is, when the pouch sheet 2A is folded, the bending lateral surface 2BS of the pouch 2 is prevented from being pushed inward and collapsing into a concave shape.

In a conventional technology, as for a battery without a bottom, when the pouch 2 is bent, the pouch 2 is moved into the main chamber, resulting in the problem that the size of the main chamber decreases.

However, in the pouch bending guide apparatus of the present disclosure, the stopper 42 is coupled to the knife and the jigs (that is, the base jig 30 and the bending jig 20) and prevents the pouch 2 from being pushed into the main chamber. That the pouch 2 is pushed into the main chamber means that the bending lateral surface 2BS on one side of the pouch 2 is pushed into the pouch 2 when forming the pouch 2 by folding the pouch sheet 2A. According to the present disclosure, during the bending of the pouch 2, the pouch 2 is prevented from being moved into the main chamber, thereby preventing the size of the main chamber of the pouch 2 from decreasing.

The bending lateral surface 2BS of the pouch 2 is prevented from being pushed inward, thereby improving the exterior quality and reliability of the pouch 2.

In addition, the pouch bending guide apparatus of the present disclosure solves the problem that heat generated during the charging/discharging of the battery cells of a secondary battery is not efficiently discharged when the bending lateral surface 2BS of the pouch 2 having battery cells mounted therein is deformed concavely inward. A plurality of pouches 2 having battery cells mounted therein (hereinafter, referred to as the pouch 2 for convenience) is placed by standing side by side on a hanger frame, and the bending lateral surface 2BS of each of the pouches 2 is in contact with a heat sink provided on the lower part of the hanger frame. In this state, heat generated in the pouch 2 during the charging/discharging of the battery cell is transmitted from the bending lateral surface 2BS to the heat sink to be discharged. The pouch 2 does not have a concave deformation part formed in such a manner that the bending lateral surface 2BS of the pouch 2 is recessed inward, and thus the bending lateral surface of the pouch 2 is not prevented from being efficiently in contact with the heat sink. The bending lateral surface of the pouch 2 is at least formed to protrude or be flat at the side of the pouch 2, and thus the bending lateral surface 2BS of the pouch 2 is securely in contact with the heat sink, and accordingly, heat generated in the pouch 2 during the charging/discharging of the battery cell is efficiently transmitted from the bending lateral surface 2BS to the heat sink, thereby efficiently discharging heat generated inside the pouch 2 during the charging/discharging of the battery cell.

In addition, heat discharge from the pouch 2 is efficiently performed, thereby preventing the battery cell from deteriorating or burning due to heat.

Furthermore, according to the present disclosure, the bending knife 40 is mounted to the bending knife support frame 60, and the bending knife support frame 60 is mounted to a bending guide frame such that the bending knife support frame 60 can be moved upward and downward, and thus the vertical position of the bending knife 40 and the vertical position of the stopper 42 of the bending knife 40 can be adjusted according to working conditions, thereby further facilitating the bending of the pouch 2.

Additionally, the front lower surface of the bending knife 40 is configured as a horizontal surface, and thus when the bending knife 40 moves to and from the inside of the folding pouch sheet 2A, the front lower surface of the bending knife 40 is prevented from being held in the pouch sheet 2A, thereby further facilitating the formation of the pouch 2 by bending the pouch sheet 2A.

### INDUSTRIAL APPLICABILITY

The present disclosure relates to the pouch bending guide apparatus, for a secondary battery packaging system, which folds the pouch sheet while the bending jig is folded toward the base jig with the pouch sheet placed on the base jig and the bending jig, the apparatus including: the bending knife which supports, from the inside of the pouch, the bending lateral surface of the pouch formed while the pouch sheet is folded by the bending jig and has industrial applicability.

1. A pouch bending guide apparatus, for a secondary battery packaging system, which folds a pouch sheet while a bending jig is folded toward a base jig with the pouch sheet placed on the base jig and the bending jig, the apparatus comprising:
a bending knife which supports, from an inside of a pouch, a bending lateral surface of the pouch formed while the pouch sheet is folded by the bending jig.

2. The apparatus of claim 1, wherein the bending knife is provided with a stopper to support an inner surface of the bending lateral surface of the pouch.

3. The apparatus of claim 2, wherein the bending knife is configured to be moved toward an inside of the pouch sheet by a movement means such that the stopper prevents movement of the bending lateral surface to the inside of the pouch.

4. The apparatus of claim 3, wherein the bending knife is disposed to be inclined, and when the bending jig and the pouch sheet are folded, the inclined bending knife is configured to be moved toward the inside of the pouch sheet by the movement means.

5. The apparatus of claim 1, wherein one side wall of the base jig and one side wall of the bending jig are connected to each other by a hinge part, and a bending guide opening part is formed in each of the side walls of the base jig and the bending jig such that inner and outer surfaces of the side wall communicate with each other.

6. The apparatus of claim 1, wherein the pouch sheet is placed on the base jig and the bending jig, and in a state in which a battery cell is received in a half battery cell receiving part disposed on the base jig among a pair of half battery cell receiving parts of the pouch sheet, the pouch sheet is folded while the bending jig is folded toward the base jig, and after the pouch sheet is folded, the pouch having the battery cell mounted in the half battery cell receiving part inside the pouch is formed, wherein the bending knife is configured to move to the inside of the pouch sheet and to support the bending lateral surface of the pouch from the inside of the pouch while the pouch sheet is folded.

7. The apparatus of claim 1, wherein a vacuum suction passage is formed inside each of the base jig and the bending jig, and a plurality of vacuum suction holes communicating with the vacuum suction passage is formed in each of inner surfaces of the base jig and the bending jig facing each other.

8. The apparatus of claim 7, wherein in a state in which the pouch sheet placed on the inner surfaces of the base jig and the bending jig is vacuum-suctioned by the vacuum suction holes of the base jig and the bending jig, the pouch sheet is folded in half by folding the bending jig toward the inner surface of the base jig, and thus the pouch is formed, and a battery cell is mounted in a battery cell receiving part inside the pouch.

9. A pouch bending method for a secondary battery packaging system, the method comprising:
bending a pouch by folding a pouch sheet while a bending jig is folded toward a base jig with the pouch sheet placed on the base jig and the bending jig; and
supporting a bending lateral surface of the pouch formed while the pouch sheet is bent, from an inside of the pouch, by moving a bending knife toward an inside of the pouch sheet folded while the pouch sheet is folded by the bending jig.
